(19) United States
(12) Patent Application Publication
(10) Pub. No.: US 2024/0286584 A1
(43) Pub. Date: Aug. 29, 2024

(54) VEHICLE SENSOR CLEANING APPARATUS AND CONTROL METHOD THEREOF

(71) Applicants: DY AUTO CORPORATION, Chungcheongnam-do (KR); DY-ESSYS CORP., Incheon (KR)

(72) Inventors: Jong Wook LEE, Chungcheongnam-do (KR); Sin Won KANG, Chungcheongnam-do (KR); Min Wook PARK, Incheon (KR); Sun Ju KIM, Incheon (KR); Hyeong Jun KIM, Incheon (KR)

(21) Appl. No.: 18/584,256

(22) Filed: Feb. 22, 2024

(30) Foreign Application Priority Data
Feb. 23, 2023 (KR) 10-2023-0024583

(51) Int. Cl. B60S 1/56; B60S 1/48; B60S 1/54

(52) U.S. Cl. CPC B60S 1/56; B60S 1/485; B60S 1/486; B60S 1/54

(57) ABSTRACT

A vehicle sensor cleaning apparatus and a control method of the vehicle sensor cleaning apparatus are disclosed. The vehicle sensor cleaning apparatus includes a liquid controller configured to control washer fluid spraying to at least one sensor located in a vehicle, and an air controller configured to control air spraying to at least one sensor located in the vehicle, wherein the liquid controller and/or the air controller are further configured to dynamically adjust a duty cycle of a control signal according to vehicle speed and/or an amount of rain.

### CROSS-REFERENCE TO RELATED APPLICATION

This application is based on and claims priority under 35 U.S.C. § 119 to Korean Patent Application No. 10-2023-0024583, filed on Feb. 23, 2023, in the Korean Intellectual Property Office, the disclosure of which is incorporated by reference herein in its entirety.

### BACKGROUND

### 1. Field

The disclosure relates to a vehicle sensor cleaning apparatus for cleaning a sensor installed on a vehicle and a control method thereof.

### 2. Description of the Related Art

Recent vehicles include various types of sensors (cameras, radars, LiDars, etc.) A vehicle sensor may not normally work when foreign materials are on the surface of the vehicle sensor. When the sensors necessary for autonomous driving or various driving assistance do not work normally, this can also affect the safety of vehicle operation. Although a system that emits washer fluid to remove foreign materials on a vehicle windshield has been used, it is difficult to employ a washer fluid emitting system to clean small sensors located in various portions of a vehicle and having small sizes.

### SUMMARY

The disclosure provides a vehicle sensor cleaning apparatus for removing foreign materials on the surface of a sensor included in a vehicle and a control method of the vehicle sensor clearing apparatus.

Additional aspects will be set forth in part in the description which follows and, in part, will be apparent from the description, or may be learned by practice of the presented embodiments of the disclosure.

According to an embodiment, a vehicle sensor cleaning apparatus includes a liquid controller configured to control washer fluid spraying to at least one sensor located in a vehicle, and an air controller configured to control air spraying to at least one sensor located in the vehicle, wherein the liquid controller and/or the air controller are further configured to dynamically adjust a duty cycle of a control signal according to vehicle speed and/or amount of rain.

According to an embodiment, a control method of a vehicle sensor cleaning apparatus includes determining vehicle speed and/or amount of rain, adjusting a duty cycle of a washer fluid control signal according to the vehicle speed and/or the amount of rain, and controlling a washer fluid spraying force or spraying amount for at least one sensor located in a vehicle by using a washer fluid control signal with an adjusted duty cycle.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an example of an overall structure of a vehicle sensor cleaning apparatus according to an embodiment;

FIG. 2 is a view illustrating another example of a vehicle sensor cleaning apparatus according to an embodiment;

FIG. 3 is a view illustrating an example of a vehicle in which a vehicle sensor cleaning apparatus is implemented, according to an embodiment;

FIG. 4 is a view illustrating an example of a cleaning direction of a sensor, according to an embodiment;

FIG. 5 is a view illustrating an example of a detailed structure of an air sprayer, according to an embodiment;

FIG. 6 is a view illustrating an example of a detailed structure of a liquid sprayer, according to an embodiment;

FIG. 7 is a view illustrating an example of an alternating control method of a vehicle sensor cleaning apparatus, according to an embodiment;

FIG. 8 is a view illustrating an example of a control method of a vehicle sensor cleaning apparatus, according to an embodiment;

FIGS. 9 and 10 are views illustrating an example of a method of adjusting a control signal of a vehicle sensor cleaning apparatus on the basis of vehicle speed;

FIG. 11 is a view illustrating an example of a method of adjusting a control signal of a vehicle sensor cleaning apparatus on the basis of the amount of rain; and

FIGS. 12 and 13 are views illustrating an example of a method of adjusting a control signal of a vehicle sensor cleaning apparatus by considering both vehicle speed and the amount of rain.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a vehicle sensor cleaning apparatus and a control method of the vehicle sensor cleaning apparatus, according to an embodiment, will be described in detail with reference to the accompanying drawings.

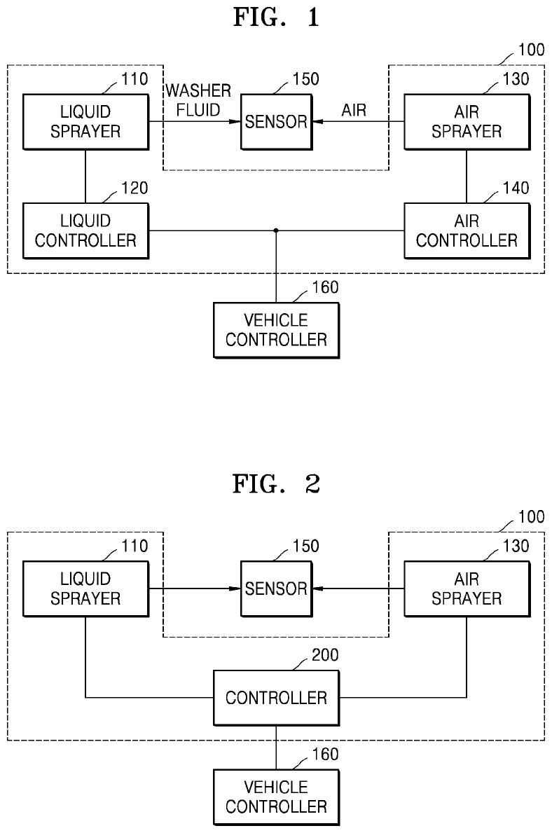

FIG. 1 is a view illustrating an example of an overall structure of a vehicle sensor cleaning apparatus according to an embodiment.

Referring to FIG. 1, a vehicle sensor cleaning apparatus 100 may include a liquid sprayer 110, a liquid controller 120, an air sprayer 130, and an air controller 140. The vehicle sensor cleaning apparatus 100 may be connected to a vehicle controller 160. In some embodiments, the vehicle sensor cleaning apparatus 100 may further include a gateway (not shown) that transmits a cleaning request of the vehicle controller 160 to each of the liquid controller 120 and the air controller 140. Each of the liquid controller 120 and the air controller 140 may be implemented with a micro controller unit (MCU) or the like.

The liquid sprayer 110 may spray washer fluid on a sensor 150. The washer fluid may include various components according to an embodiment. For example, the washer fluid may include various components such as general water or components identical to those used in a vehicle glass.

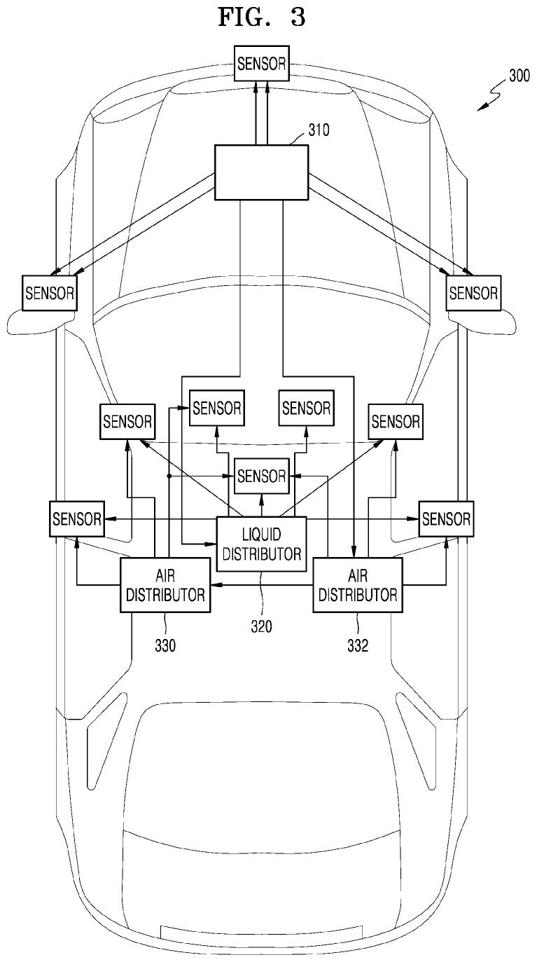

The present embodiment shows only one sensor 150 for convenience of explanation, but a vehicle may include a plurality of sensors as shown in FIG. 3. The liquid sprayer 110 may spray washer fluids simultaneously or sequentially on a plurality of sensors, or spray washer fluids only on sensors that require cleaning, and, in this regard, an example of a configuration of the liquid sprayer 110 is shown in FIG. 6.

The liquid controller 120 may control the washer fluid spraying of the liquid sprayer 110. For example, when the liquid controller 120 receives a cleaning request from the vehicle controller 160, the liquid controller 120 may control the liquid sprayer 110 to spray the washer fluid. When there is a cleaning request signal for a plurality of sensors, washer fluid spraying may be sequentially or simultaneously performed.

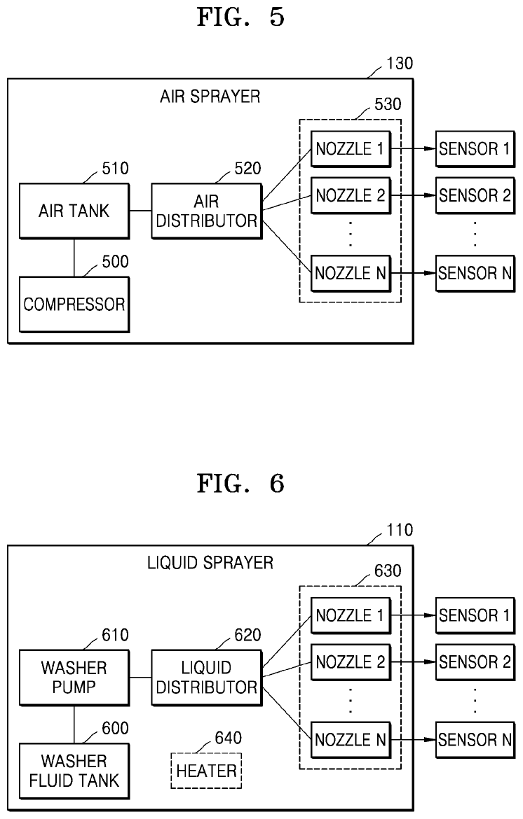

The air sprayer 130 may spray air on the sensor 150. Because there are a plurality of sensors in the vehicle, the air sprayer 130 may simultaneously or sequentially spray air on the plurality of sensors, or spray air only on sensors that require cleaning. An example of a configuration of the air sprayer 130 is shown in FIG. 5. Air sprayed on the sensor may be general air or compressed air. FIG. 5 is an example of spraying compressed air.

The air controller 140 may control the spraying of air of the air sprayer 130. For example, when the air controller 140 receives a cleaning request from the vehicle controller 160, the air controller 140 may control the air sprayer 130 to spray air.

The vehicle controller 160 may output a cleaning request command when the sensor 150 requires cleaning. For example, the vehicle controller 160 may identify a sensor that requires cleaning through various conventional methods. Because a method for the vehicle controller 160 to identify a sensor that requires cleaning is beyond the scope of the disclosure, descriptions thereof are omitted. The present embodiment is described assuming that the liquid controller 120 and the air controller 140 receive a cleaning request signal including sensor identification information from the vehicle controller 160.

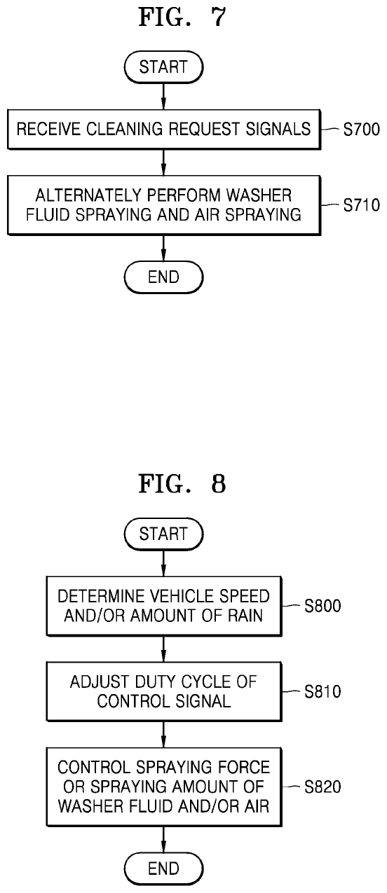

The vehicle controller 160 may only output a cleaning request command and may not limit the cleaning method. In this case, according to the cleaning request, the method of cleaning each sensor may be variously implemented. As another example, the vehicle controller 160 may output a cleaning request command specifying the cleaning method. The present embodiment provides a method of performing cleaning through washer fluid spraying and air spraying when a cleaning request is received from the vehicle controller 160. For the sensor cleaning to be performed efficiently, the washer fluid spraying and the air spraying may be alternately performed. A method of controlling the spraying operations of the liquid sprayer 110 and the air sprayer 130 so as not to overlap each other will be described with reference to FIG. 7.

In another embodiment, the vehicle controller 160 may output information, such as vehicle speed and/or amount of rain. In another embodiment, the liquid controller 120 and/or the air controller 140 may receive information, such as vehicle speed and/or amount of rain, directly from other components of the vehicle other than the vehicle controller 60. It is already a known configuration to detect the amount of rain in a vehicle through a rain sensor for a wiper's automatic mode. Hereinafter, for convenience of explanation, the description will be made assuming that the liquid controller 120 and/or the air controller 140 receives information, such as vehicle speed and amount of rain, through the vehicle controller 160.

FIG. 2 is a view illustrating another example of the vehicle sensor cleaning apparatus according to an embodiment.

Referring to FIG. 2, a vehicle sensor cleaning apparatus 100 may include a liquid sprayer 110, an air sprayer 130, and a controller 200. The vehicle sensor cleaning apparatus 100 may be connected to a vehicle controller 160. Because the liquid sprayer 110, the air sprayer 130, the vehicle controller 160, and a sensor 150 of the present embodiment are the same as the configuration of FIG. 1, the descriptions corresponding thereto are omitted.

The present embodiment may include the controller 200 in which the liquid controller 120 and the air controller 140 of FIG. 1 are integrated. When the controller 200 receives a cleaning request from the vehicle controller 160, the liquid sprayer 110 and the air sprayer 130 may be controlled to simultaneously or sequentially spray the washer fluid and air. Each configuration and function of the liquid controller 120 and the air controller 140 may be integrally implemented in the controller 200.

However, hereinafter, for convenience of explanation, descriptions will be made based on the configuration of FIG. 1. Therefore, the functions and configurations of the liquid controller 120 and the air controller 140, which will be described later, may be implemented with the controller 200 of FIG. 2.

FIG. 3 is a view illustrating an example of a vehicle in which the vehicle sensor cleaning apparatus is implemented, according to an embodiment.

Referring to FIG. 3, a plurality of sensors are provided in a vehicle 300. On one side 310 of the vehicle, some components of the liquid sprayer 110 and the air sprayer 130 (e.g., an air tank and a washer fluid tank of FIGS. 5 and 6) may be provided. The present embodiment shows a case in which the air tank and the washer fluid tank are arranged in one location, but this is only an example, and the air tank and the washer fluid tank may be arranged in different locations of the vehicle. In some embodiments, a plurality of air tanks and a plurality of washer fluid tanks may be provided.

A nozzle that sprays air and/or washer fluid may be arranged in each sensor. Air is sprayed on the sensor through the air nozzle of FIG. 5, and the washer fluid is sprayed on the sensor through the liquid nozzle of FIG. 6.

One or more air distributors 330 and 332 may be provided for supplying compressed air of the air tank to the air nozzle arranged in each sensor. The air controller 140 may spray air on a desired sensor by controlling the air distributor 330 and 332.

One or more liquid distributors 320 may be provided for supplying the washer fluid of the washer fluid tank to the liquid nozzle arranged in each sensor. The liquid controller 120 may spray the washer fluid on a desired sensor by controlling the liquid distributor 320.

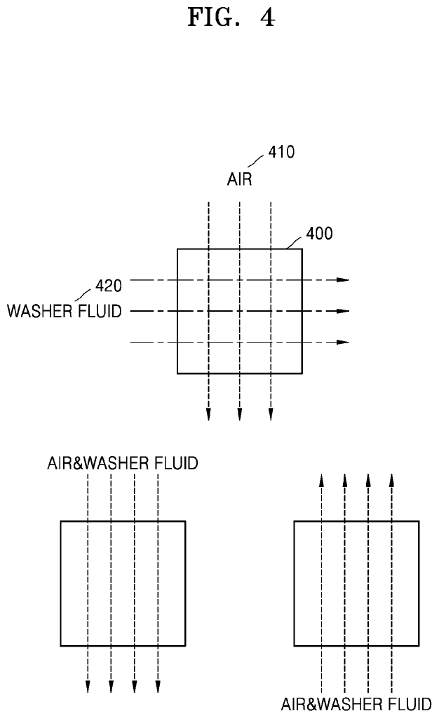

FIG. 4 is a view illustrating an example of a cleaning direction of a sensor, according to an embodiment.

Referring to FIG. 4, a direction 420 of a washer fluid sprayed on the surface of a sensor 400 and a direction 410 of air sprayed on the surface of the sensor 400 may be different from each other. In addition, the washer fluid and the air may be simultaneously or sequentially sprayed, or only one of the washer fluid and the air may be sprayed. For example, the liquid sprayer 110 may spray the washer fluid from the left to the right on the sensor 400, and the air sprayer 130 may spray the air from the top to the bottom of the sensor 400. The washer fluid and air sprayed in different directions may effectively remove foreign materials on the surface of the sensor 400. For example, air may be sprayed from the top to the bottom to remove the washer fluid or rainwater left on the surface of the sensor 400.

In another embodiment, the direction 420 of the washer fluid sprayed on the surface of the sensor 400 and the direction 410 of the air may be the same. For example, the washer fluid and the air may be sprayed from the top to the bottom (or from the bottom to the top) of the sensor 400. Through the simultaneous spraying of the washer fluid and air, the pressure on the surface of the sensor may be increased to effectively remove foreign materials on the surface. In addition, the direction and order of spraying the washer fluid and the air may vary depending on embodiments.

FIG. 5 is a view illustrating an example of a detailed structure of an air sprayer, according to an embodiment.

Referring to FIG. 5, an air sprayer 130 may include a compressor 500, an air tank 510, an air distributor 520, and a plurality of nozzles 530.

The compressor 500 may compress and stores air in the air tank 510. In an embodiment, the compressor 500 may include a plurality of motors. In this case, the compressor 500 may alternately use a plurality of motors to prevent a load from being added to one motor. A compressor 500 including one motor may be implemented. In another embodiment, a compression intensity of air stored in the air tank 510 may be adjusted through the compressor 500.

The air tank 510 may store the compressed air. In an embodiment, air may be sprayed on the sensor by using a propeller, etc. without the compressor 500 and the air tank 510. However, since the intensity of air generated through the propeller, etc. is weak, it is difficult to cleanly remove foreign materials or water on the surface of the sensor. Therefore, the present embodiment may increase the intensity (e.g., the speed or spraying force) of air sprayed on the sensor by using compressed air stored in the air tank 510.

The air distributor 520 may distribute compressed air output from the air tank 510 to the plurality of nozzles 530. The nozzles 530 may be respectively arranged in the sensors and spray air on the sensors. In an example, the air distributor 520 may include a plurality of channels that output compressed air, and the channels are respectively connected to the nozzles 530 through air hoses. When the number of sensors is greater than the number of channels of the air distributor 520, a plurality of air distributors 520 may be provided. For example, the plurality of air distributors 520 may each be connected in parallel to the air tank 510, or the plurality of air distributors 520 may be connected to each other in a hierarchical structure such as a tree structure.

The air distributor 520 may turn on/off each channel under the control of the air controller 140. For example, when the air distributor 520 receives an on command of a first channel from the air controller 140, the air distributor 520 may output compressed air of the air tank 510 through the first channel, and a first nozzle connected to the first channel through an air hose may spray air on a first sensor. The on/off of the channel may be controlled through a solenoid valve, etc.

To control the performance of the air distributor 520 of turning each channel on/off, the air controller 140 may identify and store, in advance, which channel of the air distributor 520 each sensor is connected to. For example, if a relationship between first sensor identification information and the first channel is defined, when cleaning of the first sensor is required, the air controller 140 may transmit the on command of the first channel of the air distributor 520 to the air distributor 520.

FIG. 6 is a view illustrating an example of a detailed structure of a liquid sprayer, according to an embodiment.

Referring to FIG. 6, a liquid sprayer 110 may include a washer fluid tank 600, a washer pump 610, a liquid distributor 620, and at least one nozzle 630.

The washer fluid tank 600 may store the washer fluid. The washer pump 610 may output the washer fluid stored in the washer fluid tank 600 to the liquid distributor 620. The liquid distributor 620 may output the washer fluid received through the washer pump 610 through the nozzle 630. The washer pump 610 may output the washer fluid through motor driving. The nozzle 630 may spray the washer fluid on the sensor. Each nozzle 630 may be connected to the liquid distributor 620 through a liquid hose. In an embodiment, the nozzle 630 may protrude when the washer fluid is sprayed onto the sensor and retract back in when spraying is completed.

In another embodiment, there may be a plurality of washer pumps 610. For example, when there are 20 nozzles, 1st to 10th nozzles may be connected to a first washer pump (or a first motor), 11th to 14th nozzles may be connected to a second washer pump (or a second motor), and 15th to 20th nozzles may be connected to a third washer pump (or a third motor). The liquid controller 120 may control a plurality of washer pumps (or a plurality of motors) in parallel.

The liquid distributor 620 may select the nozzle 630 to output the washer fluid according to the control of the liquid controller 120. In an example, the liquid distributor 620 may include a plurality of channels that output the washer fluid, and the channels are respectively connected to the nozzles 630 through liquid hoses. When the number of sensors becomes greater than the number of channels of the liquid distributor 620, a plurality of liquid distributors 620 may be provided. For example, the plurality of liquid distributors 620 may each be connected in parallel to the washer pump 610, or the plurality of liquid distributors 620 may be connected to each other in a hierarchical structure such as a tree structure.

The liquid distributor 620 may spray the washer fluid on the desired sensor by turning on/off the plurality of channels. When the liquid distributor 620 receives the on command of the first channel from the liquid controller 120, the washer fluid is output through the first channel, and the first nozzle connected to the first channel may spray the washer fluid on the first sensor. The liquid controller 120 may identify and store in advance which channel of the liquid distributor 620 each sensor is connected to, like the air controller 140 described above. For example, if a relationship between the first sensor identification information and the first channel is defined in advance, when cleaning of the first sensor is required, the liquid controller 120 may transmit the on command of the first channel of the liquid distributor 620 to the liquid distributor 620. In an embodiment, each channel connected to each nozzle may be turned on/off through a solenoid valve.

In some embodiments, the liquid sprayer 110 may further include a heater 640. The heater 640 may supply heat to the liquid hose connecting each nozzle 630 to the liquid distributor 620, the washer pump 610, the washer fluid tank 600, or the liquid distributor 620. For example, when the external temperature is low, such as in winter, etc., the washer fluid in the liquid hose or liquid distributor 620 may freeze, and thus, the heater 640 may prevent the washer fluid from being frozen. In an embodiment, the liquid controller 120 may operate the heater 640 when the liquid controller 120 receives a command to operate the heater 640 or when an external temperature identified through a temperature sensor is less than a preset temperature.

FIG. 7 is a view illustrating an example of an alternating control method of a vehicle sensor cleaning apparatus, according to an embodiment.

Referring to FIG. 7, the liquid controller 120 and/or the air controller 140 may receive a cleaning request signal from the vehicle controller 160 (S700). The cleaning request signal may include identification information on at least one sensor to be cleaned. The liquid controller 120 and/or the air controller 140 may be connected to the vehicle controller 160 via Controller Area Network (CAN) or CAN with Flexible Data Rat (CAN FD).

The washer fluid spraying control start point of the liquid controller 120 and the air spraying control start point of the air controller 140 may be different from each other to allow washer fluid and air to be alternately sprayed (S710). For example, the liquid controller 120 and the air controller 140 may control washer fluid spraying and air spraying to be alternately performed for the same sensor.

An alternating control method for the same sensor may be implemented in various ways.

In an embodiment, when the liquid controller 120 receives a cleaning request signal, the liquid controller 120 may convert the mode to a liquid spray mode, in which washer fluid is sprayed on a sensor corresponding to the cleaning request signal, and inform the air controller 140 of the on state of the liquid spray mode. The liquid controller 120 may be connected to the air controller 140, and the air controller 140 may not perform air spraying when receiving the on state of the liquid spray mode. If air is being sprayed when the air controller 140 receives the on status of the liquid spray mode, the air controller 140 may immediately stop spraying air. When the air controller 140 confirms that the liquid spray mode is in an off state through the liquid controller 120, the air controller 140 may perform air spraying according to a cleaning request signal. The air controller 140 may request and receive the status of the liquid spray mode from the liquid controller 120 at regular intervals, or the liquid controller 120 may send status information to the air controller 140 whenever the status of the liquid spray mode changes. In addition, the liquid controller 120 and the air controller 140 may share the state of the liquid spray mode through various methods.

In another embodiment, when the washer cleaning request and the air cleaning request simultaneously occur, the liquid controller 120 may immediately output a control signal for washer fluid spraying according to the washer cleaning request. When the air controller 140 receives the air cleaning request, the air controller 140 may output a control signal for air spraying after a predefined period of time has elapsed. That is, there is a certain time interval between the start point of a washer fluid spraying operation and the start point of an air spraying operation. For example, the liquid controller 120 may control the liquid sprayer 110 to spray washer fluid for a time t1 after receiving the washer cleaning request, and the air controller 140 may control the air sprayer 130 to spray air after the time t1 has elapsed after receiving the air cleaning request.

In another embodiment, washer fluid spraying and air spraying may be controlled to be alternately performed repeatedly. The liquid controller 120 may repeat the washer fluid spraying operation at regular periodic intervals, and the air controller 140 may also repeat the air spraying operation at regular periodic intervals. For example, the liquid controller 120 and the air controller 140 may repeat an on signal for the spraying operation at regular intervals. During an on signal period, washer fluid spraying or air spraying may be performed, and during an off signal period, a washer fluid or air spraying operation may not be performed. When the washer fluid spraying operation timing point and the air spraying operation time point are different from each other, the cycles of the two operations are the same, and the on signal period for washer fluid spraying and the on signal period for air spraying do not overlap each other, the washer spraying operation and the air spraying operation may not overlap each other and alternate with each other.

FIG. 8 is a view illustrating an example of a control method of a vehicle sensor cleaning apparatus according to an embodiment.

Referring to FIG. 8, the liquid controller 120 and/or the air controller 140 may determine the vehicle speed and/or the amount of rain (S800). Various conventional methods of determining the vehicle speed and/or the amount of rain may be applied to the present embodiment.

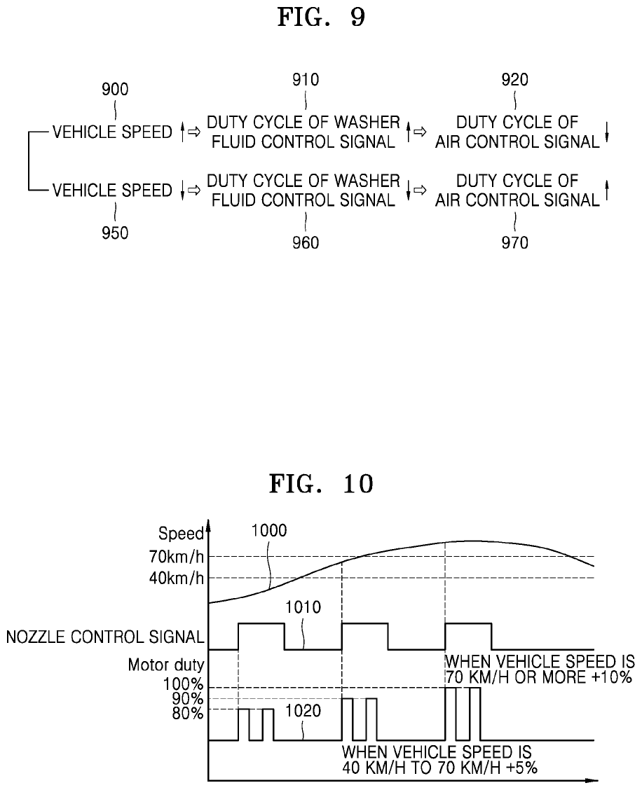

The liquid controller 120 may control washer fluid spraying to at least one sensor located in a vehicle, and the air controller 140 may control air spraying to at least one sensor located in the vehicle. A control signal output by the liquid controller 120 and/or the air controller 140 may be a pulse width modulation (PWM) control signal. The liquid controller 120 and/or the air controller 140 may dynamically adjust the duty cycle of the control signal (an air control signal and/or a washer fluid control signal) according to the vehicle speed and/or the amount of rain (S810). Various examples of methods of dynamically controlling the duty cycle of the control signal will be described again with reference to FIGS. 9 to 13.

The liquid controller 120 and/or the air controller 140 may control the liquid sprayer 110 and/or the air sprayer 130 according to the duty cycle of the control signal to adjust the spraying force or spraying amount of washer fluid or air (S820). For example, the air controller 120 may control the intensity of compressed air by controlling a motor of the compressor 500 according to the duty cycle, thereby controlling the intensity (spraying force) of air output through a nozzle, and the liquid controller 140 may control the intensity (spraying force) of washer fluid output through the nozzle by controlling a motor of the washer pump 610 according to the duty cycle.

FIGS. 9 and 10 are views illustrating an example of a method of adjusting a control signal of a vehicle sensor cleaning apparatus based on vehicle speed.

Referring to FIGS. 9 and 10, the liquid controller 120 may adjust the duty cycle of the washer fluid control signal in proportion to the vehicle speed to increase the washer fluid spraying force as the vehicle speed increases (900). For example, the liquid controller 120 may increase the duty cycle of the washer fluid control signal (910) when the vehicle speed increases (900), and may decrease the duty cycle of the washer fluid control signal (960) when the vehicle speed decreases (950).

The liquid controller 120 may predefine and store the relationship between the vehicle speed and the duty cycle of the washer fluid control signal. For example, referring to FIG. 10, the liquid controller 120 may divide a vehicle speed 1000 into a plurality of sections (e.g., 40 km/h or less, 40 km/h to 70 km/h, and 70 km/h or more), and may predefine and store a duty cycle 1020 (e.g., for 40 km/h or less, duty cycle=80%, for 40 km/h to 70 km/h, duty cycle=90%, and for 70 km/h or more, duty cycle=100%) for each section. As another example, the liquid controller 120 may predefine and store an adjustment range of a duty cycle according to a vehicle speed after defining a reference duty cycle (for example, when the vehicle speed is 40 km/h or less, the reference duty cycle is unchanged, when the vehicle speed is 40 km/h to 70 km/h, the reference duty cycle is increased by 5%, and when the vehicle speed is 70 km/h or more, the reference duty cycle is increased by 10%.) The liquid controller 120 may determine the duty cycle of a washer fluid control signal according to a vehicle speed by using a predefined relationship between the vehicle speed 1000 and the duty cycle 1020.

The air controller 140 may adjust the duty cycle of an air control signal in inverse proportion to a vehicle speed in order to reduce the air spraying force as the vehicle speed increases (900). For example, the air controller 140 may decrease the duty cycle of the air control signal (920) when the vehicle speed increases (900), and may increase the duty cycle of the air control signal (970) when the vehicle speed decreases (950). As the vehicle speed increases, the driving wind increases, and thus, even when the spraying force of the air spraying is weak, a certain level of cleaning effect may be achieved. Therefore, the lifespan of a compressor motor may be increased by reducing the number of operations of the compressor motor, and spraying performance may be optimized by minimizing the use of charged air.

In an embodiment, the air controller 140 may predefine the relationship between the vehicle speed and the duty cycle of the air control signal and then use the relationship to determine the duty cycle of the air control signal according to the vehicle speed. To this end, the air controller 140 may predefine and store a duty cycle or duty cycle adjustment range for each vehicle speed section.

In another embodiment, the air controller 140 may adjust the duty cycle of the air control signal according to a duty cycle adjustment value of the liquid controller 120. When the air controller 140 confirms that the liquid controller 120 has adjusted the duty cycle of the washer fluid control signal, the air controller 140 may adjust the duty cycle of the air control signal according to an adjustment value of the duty cycle of the washer fluid control signal. The duty cycle adjustment direction of the liquid controller 120 and the duty cycle adjustment direction of the air controller 140 may be opposite to each other. For example, when the liquid controller 120 adjusts the duty cycle of the washer fluid control signal upward by 10%, the air controller 140 may adjust the current duty cycle of the air control signal downward by 10%. Conversely, when the liquid controller 120 adjusts the duty cycle of the washer fluid control signal downward by 10%, the air controller 140 may adjust the current duty cycle of the air control signal upward by 10%. The adjustment ratio of the duty cycle of the washer fluid control signal of the liquid controller 120 and the adjustment ratio of the duty cycle of the air control signal of the air controller 140 do not need to be the same. For example, when the duty cycle of the washer fluid control signal is adjusted by 10%, the duty cycle of the air control signal may be adjusted by 8%, and the two adjustment ratios may be set in various ways. In another embodiment, the air spraying time point of the air controller 140 may be controlled using the alternate control method described with reference to FIG. 7.

In another embodiment, the liquid controller 120 may control not only the spraying force of the washer fluid but also the spraying amount, such as the number of sprayings, depending on the vehicle speed. For example, the liquid controller 120 may increase the number of washer fluid sprayings when the vehicle speed increases, and may decrease the number of washer fluid sprayings when the vehicle speed decreases. For example, the liquid controller 120 may output a nozzle control signal 1010 for turning on the nozzle of a sensor to be cleaned, and may repeatedly output a plurality of control signals while the sensor nozzle is in an on period and control washer fluid to be sprayed to the sensor multiple times. To this end, the liquid controller 120 may predefine information, such as the number of control signal outputs (i.e., length of a PWM control signal) according to vehicle speed. The air controller 140 may adjust the number of air sprayings according to the number of washer fluid sprayings of the liquid controller 120. For example, the air controller 140 may control air spraying to occur once per washer fluid spraying by using the alternate control method of FIG. 7.

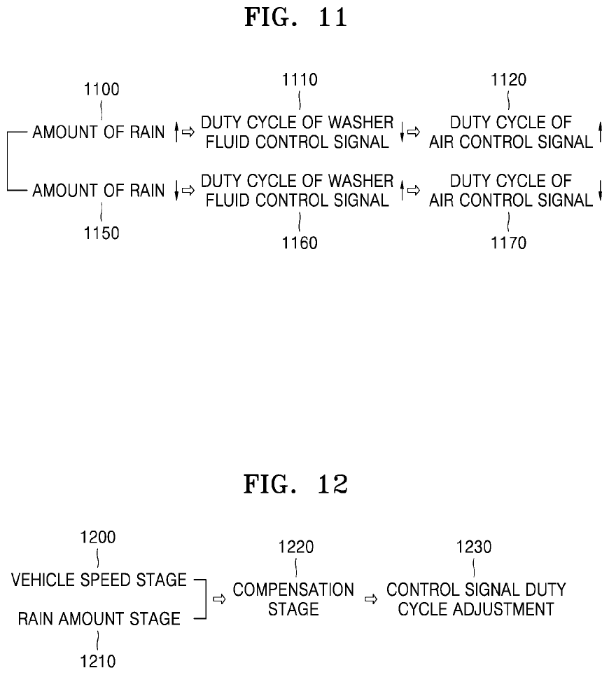

FIG. 11 is a view illustrating an example of a method of adjusting a control signal of a vehicle sensor cleaning apparatus based on the amount of rain.

Referring to FIG. 11, the liquid controller 120 may dynamically adjust the duty cycle of the washer fluid control signal according to the amount of rain. For example, the liquid controller 120 may decrease the duty cycle of the washer fluid control signal (1120) when the amount of rain increases (1100), and may increase the duty cycle of the washer fluid control signal (1160) when the amount of rain decreases (1150). In rainy weather, a certain level of cleaning effect may be achieved with a small amount of washer fluid. Washer fluid waste may be prevented by reducing the amount of washer fluid sprayed in rainy weather.

The liquid controller 120 may predefine and store the relationship between the amount of rain and the duty cycle of the washer fluid control signal. For example, the liquid controller 120 may divide the rain amount into a plurality of sections and predefine and store a duty cycle for each section. Depending on the type of rain amount information provided by the vehicle, sections of the rain amount may be classified in various ways. As another example, the liquid controller 120 may define a reference duty cycle and then predefine and store an adjustment range of a duty cycle according to the amount of rain. The liquid controller 120 may determine the duty cycle of a washer fluid control signal according to the amount of rain by using a predefined relationship between the amount of rain and the duty cycle.

The air controller 140 may dynamically adjust the duty cycle of the air control signal according to the amount of rain. For example, when the amount of rain increases (1100), the air controller 140 may increase the duty cycle of the air control signal (1120) to increase the spraying force or amount of air, and when the amount of rain decreases (1150), the air controller 140 may decrease the duty cycle of the air control signal (1120) to decrease the spraying force or amount of air. To this end, the air controller 140 may predefine the relationship between the amount of rain and the duty cycle of the air control signal.

In another embodiment, the air controller 140 may adjust the duty cycle of the air control signal according to a duty cycle adjustment value of the liquid controller 120 without having to store the relationship between the amount of rain and the duty cycle of the air control signal in advance. When the air controller 140 confirms that the liquid controller 120 has adjusted the duty cycle of the washer fluid control signal, the air controller 140 may adjust the duty cycle of the air control signal according to an adjustment value of the duty cycle of the washer fluid control signal. The example of the control method of the air controller 140 according to the vehicle speed, described with reference to FIG. 9, may be applied to the present embodiment.

In another embodiment, the liquid controller 120 and/or the air controller 140 may prioritize the amount of rain when adjusting the duty cycle of the washer fluid control signal and/or the duty cycle of the air control signal. For example, in rainy weather, the duty cycle of a control signal may be adjusted by the method described with reference to FIG. 11, and when it is not rainy, the duty cycle of the control signal may be adjusted by the method described with reference to FIGS. 9 and 10.

In another embodiment, the liquid controller 120 may control not only the spraying force of the washer fluid but also the spraying amount, such as the number of sprayings, depending on the amount of rain. For example, the liquid controller 120 may decrease the number of washer fluid sprayings when the amount of rain increases, and may increase the number of washer fluid sprayings when the amount of rain decreases. For example, the liquid controller 120 may turn on the nozzle of a sensor to be cleaned, and may repeatedly output a plurality of control signals while the sensor nozzle is in an on period and control washer fluid to be sprayed to the sensor multiple times. To this end, the liquid controller 120 may predefine information, such as the number of times a control signal is output according to the amount of rain. The air controller 140 may adjust the number of air sprayings according to the number of washer fluid sprayings of the liquid controller 120. For example, the air controller 140 may control air spraying to occur once per washer fluid spraying by using the alternate control method of FIG. 7.

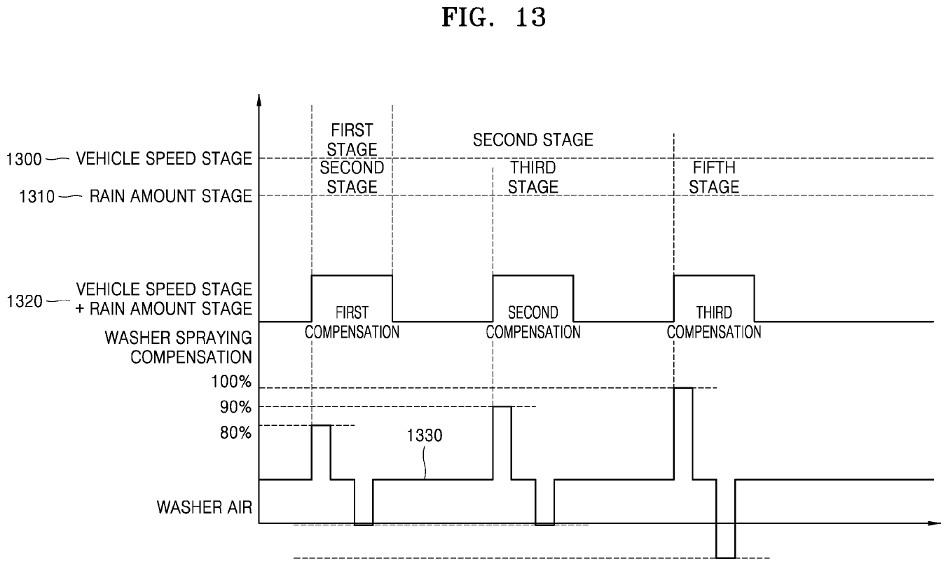

FIGS. 12 and 13 are views illustrating an example of a method of adjusting a control signal of a vehicle sensor cleaning apparatus by considering both the vehicle speed and the amount of rain.

Referring to FIGS. 12 and 13, the liquid controller 120 and/or the air controller 140 may adjust the duty cycle of a control signal by considering both the vehicle speed and the amount of rain.

The liquid controller 120 may determine a vehicle speed stage 1200 or 1300. For example, when a vehicle speed section is divided into three stages, the liquid controller 120 may determine which stage the current vehicle speed corresponds to. In addition, the liquid controller 120 may determine a rain amount stage 1210 or 1310. For example, when a rain amount section is divided into five stages, the liquid controller 120 may determine which stage the current rain amount corresponds to.

The liquid controller 120 may determine a duty cycle compensation stage 1220 or 1320 of a control signal according to the vehicle speed stage 1200 or 1300 and the rain amount stage 1210 or 1310. The liquid controller 120 may predefine a plurality of compensation stages 1220 and 1320 that define duty cycle adjustment values for various combinations of the vehicle speed stage 1200 or 1300 and the rain amount stage 1210 or 1310. In the compensation stages 1220 and 1320, both a duty cycle adjustment value of the washer fluid control signal and a duty cycle adjustment value of the air control signal may be defined (1330), or only a duty cycle adjustment value of the washer fluid control signal may be defined. When only the duty cycle adjustment value of the washer fluid control signal is defined, the duty cycle adjustment value of the air control signal may be determined at a predefined ratio according to the duty cycle adjustment value of the washer fluid control signal.

For example, a first compensation stage, which includes a duty cycle adjustment value when the vehicle speed stage 1200 or 1300 is a first stage and the rain amount stage 1210 or 1310 is first to second stages, may be defined, a second compensation stage when the vehicle speed stage 1200 or 1300 is a second stage and the rain amount stage 1210 or 1310 is a third stage may be defined, and a third compensation stage when the rain amount stage 1210 or 1310 is a five stage may be defined. The third compensation stage may be controlled so that only washer fluid is sprayed without air spraying. In addition, the compensation stages 1220 and 1320 for various combinations of the vehicle speed stage 1200 or 1300 and the rain amount stage 1210 or 1310 may be defined in various ways.

The liquid controller 120 may adjust the duty cycle of the washer fluid control signal 1230 according to the compensation stages 1220 and 1320 identified based on the vehicle speed stage 1200 or 1300 and the rain amount stage 1210 or 1310. The air controller 140 may adjust the duty cycle of the air control signal in a direction opposite to the duty cycle adjustment direction of the liquid controller 120. For example, when the liquid controller 120 adjusts the duty cycle of the washer fluid control signal upward, the air controller 140 may adjust the duty cycle of the air control signal downward. Conversely, when the liquid controller 120 adjusts the duty cycle of the washer fluid control signal downward, the air controller 140 may adjust the duty cycle of the air control signal upward. The upward (or downward) adjustment ratio of the duty cycle of the washer fluid control signal adjusted by the liquid controller 120 and the downward (or upward) adjustment ratio of the duty cycle of the air control signal adjusted by the air controller 140 may be the same or different from each other and may be modified in various ways depending on embodiments.

For example, when the vehicle speed stage is the first stage (that is, the vehicle speed is 40 km/h or less) and the rain amount stage is the first to second stage, the liquid controller 120 may decrease the duty cycle of the washer fluid control signal by 5% according to the duty cycle adjustment value defined in the first compensation stage and the air controller 140 may increase the duty cycle of the air control signal by 20%. As another example, when the vehicle speed stage is the third stage (that is, the vehicle speed is 70 km/h or more) and the rain amount stage is the second to third stage, the liquid controller 120 may decrease the duty cycle of the washer fluid control signal by 10% according to the duty cycle adjustment value defined in the second compensation stage and the air controller 140 may increase the duty cycle of the air control signal by 50%. As another example, when the rain amount stage is the five stage, washer fluid spraying may be turned off according to the duty cycle adjustment value defined in the third compensation stage and the air controller 140 may increase the duty cycle of the air control signal by 70%. That is, when the rain amount stage is the five stage, only air may be sprayed without washer fluid spraying.

The disclosure may also be implemented as a computer-readable program code on a computer-readable record medium. The computer-readable recording medium may include every type of recording device storing data readable by a computer system. Examples of the computer-readable recording media may include ROM, RAM, CD-ROM, magnetic tapes, floppy disks, optical data storage devices, etc. In addition, the computer-readable recording media may be distributed to a computer system connected by a network such that a computer-readable code may be stored and executed in a distributed method.

According to an embodiment, foreign materials on the surface of a sensor included in a vehicle may be cleanly removed using washer fluid and/or air. In addition, sensor cleaning performance may be maintained by controlling the spraying force or amount of washer fluid according to vehicle speed and/or the amount of rain, and the waste of washer fluid may be prevented by reducing unnecessary spraying of washer fluid. In another embodiment, sensor cleaning performance may be maintained by controlling the spraying force or amount of air according to vehicle speed and/or the amount of rain, and the lifespan of a compressor motor that blows out air may be increased by eliminating unnecessary air spraying.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A vehicle sensor cleaning apparatus comprising:
a liquid controller configured to control washer fluid spraying to at least one sensor located in a vehicle; and
an air controller configured to control air spraying to at least one sensor located in the vehicle,
wherein the liquid controller and/or the air controller are further configured to dynamically adjust a duty cycle of a control signal according to vehicle speed and/or an amount of rain.

2. The vehicle sensor cleaning apparatus of claim 1, wherein the liquid controller is further configured to adjust a duty cycle of a washer fluid control signal in proportion to the vehicle speed to increase a washer fluid spraying force as the vehicle speed increases.

3. The vehicle sensor cleaning apparatus of claim 1, wherein the air controller is further configured to adjust a duty cycle of an air control signal in inverse proportion to the vehicle speed to reduce an air spraying force as the vehicle speed increases.

4. The vehicle sensor cleaning apparatus of claim 1, wherein the liquid controller and/or the air controller are further configured to predefine a duty cycle of the control signal for each of a plurality of vehicle speed sections and adjust the duty cycle of the control signal according to the vehicle speed.

5. The vehicle sensor cleaning apparatus of claim 1, wherein the air controller is further configured to: when confirming that the liquid controller has adjusted a duty cycle of a washer fluid control signal, adjust a duty cycle of an air control signal according to an adjustment value of the duty cycle of the washer fluid control signal.

6. The vehicle sensor cleaning apparatus of claim 1, wherein a duty cycle adjustment direction of the liquid controller and a duty cycle adjustment direction of the air controller are opposite to each other.

7. The vehicle sensor cleaning apparatus of claim 1, wherein the liquid controller and/or the air controller are further configured to dynamically adjust a number of washer fluid sprayings or air sprayings according to the vehicle speed.

8. The vehicle sensor cleaning apparatus of claim 1, wherein the liquid controller and/or the air controller are further configured to dynamically adjust the duty cycle of the control signal according to the vehicle speed and the amount of rain.

9. The vehicle sensor cleaning apparatus of claim 8, wherein the liquid controller is further configured to reduce a duty cycle of a washer fluid control signal in inverse proportion to the amount of rain in order to reduce an amount of washer fluid spraying as the amount of rain increases.

10. The vehicle sensor cleaning apparatus of claim 8, wherein the air controller is further configured to increase a duty cycle of an air control signal in proportion to the amount of rain in order to increase an amount of air spraying as the amount of rain increases.

11. A control method of a vehicle sensor cleaning apparatus, the control method comprising:
determining vehicle speed and/or an amount of rain;
adjusting a duty cycle of a washer fluid control signal according to the vehicle speed and/or the amount of rain; and
controlling a washer fluid spraying force or spraying amount for at least one sensor located in a vehicle, by using a washer fluid control signal with an adjusted duty cycle.

12. The control method of claim 11, further comprising:
adjusting a duty cycle of an air control signal according to an adjustment value of the duty cycle of the washer fluid control signal; and
controlling an air spraying force or spraying amount for the at least one sensor located in the vehicle, by using an air control signal with an adjusted duty cycle.

13. The control method of claim 12, wherein the adjusting of the duty cycle of the washer fluid control signal includes adjusting the duty cycle of the washer fluid control signal to be proportional to the vehicle speed and inversely proportional to the amount of rain, and the adjusting of the duty cycle of the air control signal includes adjusting the duty cycle of the air control signal to be inversely proportional to the vehicle speed and proportional to the amount of rain.

14. The control method of claim 12, wherein the duty cycle of the washer fluid control signal and the duty cycle of the air control signal are adjusted with priority given to the amount of rain.

15. A computer-readable recording medium having recorded thereon a computer program for performing the method of claim 11.
